(19) United States
(12) Patent Application Publication
(10) Pub. No.: US 2019/0064828 A1
(43) Pub. Date: Feb. 28, 2019

(54) AUTONOMOUS YARD VEHICLE SYSTEM

(71) Applicant: Walmart Apollo, LLC, Bentonville, AR (US)

(72) Inventors: John S. Meredith, Bentonville, AR (US); Andrew B. Millhouse, Gilbert, AZ (US); Jacob R. Schrader, Sterling, IL (US)

(21) Appl. No.: 16/116,273

(22) Filed: Aug. 29, 2018

Related U.S. Application Data
(60) Provisional application No. 62/551,431, filed on Aug. 29, 2017.

(51) Int. Cl. G05D 1/02; G05D 1/00

(52) U.S. Cl. CPC G05D 1/0212; B62D 53/0842; G05D 1/0242; G05D 1/0088

(57) ABSTRACT

Autonomous yard vehicle management systems and methods are described. An autonomous yard vehicle system comprises a chassis, at least one freely rotating wheel disposed proximate to a distal end of the chassis, a first drive wheel driven by a first motor, a second drive wheel driven by a second motor, a coupling configured to mechanically couple with a cargo trailer, a plurality of sensors disposed about the chassis, and a computing system programmed to navigate to the cargo trailer and guide the coupling between the autonomous yard vehicle and the cargo trailer.

### RELATED APPLICATION

This application claims the benefit of, and priority to U.S. Provisional Patent Application No. 62/551,431, filed Aug. 29, 2017, the content of which is incorporated herein by reference in its entirety.

### BACKGROUND

In a distribution center, cargo trailers are constantly moved to and from doors and docks in the yard. Tractors can be assigned to the cargo trailers by a yard management system to move the trailer to the assigned door or dock.

### BRIEF DESCRIPTION OF THE DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a block diagram showing an autonomous yard vehicle system according to various embodiments of the present disclosure.

FIG. 2A illustrates a cutaway top view of an autonomous yard vehicle according to various embodiments of the present disclosure.

FIG. 2B illustrates a top view of an autonomous yard vehicle according to various embodiments of the present disclosure.

FIG. 2C illustrates a bottom view of an autonomous yard vehicle according to various embodiments of the present disclosure.

FIG. 2D illustrates a side view of an autonomous yard vehicle according to various embodiments of the present disclosure.

FIGS. 3A and 3B illustrate side views of the autonomous yard vehicle coupled with a cargo trailer according to various embodiments of the present disclosure.

FIG. 3C illustrates a top view of the autonomous yard vehicle coupled with the cargo trailer according to various embodiments of the present disclosure.

FIG. 4 is a flow diagram illustrating a method performed by the autonomous yard vehicle system according to various embodiments of the present disclosure.

FIG. 5 is a block diagram of an exemplary computational device with various components which can be used to implement various embodiments.

FIG. 6 is block diagram of an exemplary distributed system suitable for use in exemplary embodiments.

### DETAILED DESCRIPTION

Methods and systems are provided herein managing autonomous yard vehicles. An autonomous yard vehicle management system can direct the autonomous yard vehicles, for example, autonomous tractors, to move cargo trailers in the yard of a distribution center. The system can queue the autonomous vehicles and cargo trailers that require movement in the yard, and assign the autonomous tractors to the trailers and designate destinations (e.g., loading docks, parking areas) to which the trailers will be moved based upon assignment rules.

The system can be connected to physical devices in the distribution center and yard according to safety requirements. For example, the tractor may not pull away from the loading dock until the trailer doors are closed, the loading dock door is closed, or the dock plate is retracted, etc. An array of sensors can be used to monitor the doors, dock plate, tractor location, etc. Additional safety features can be added, such as using red/green indicator lights at the dock doors.

The system can also be used for managing automated truck loading and unloading devices including a platform loading and/or unloading facility.

Accordingly, systems and methods provided herein allow the autonomous yard vehicle management system to assign an autonomous yard vehicle to move a trailer to a specified location. Based on the assignment the autonomous yard vehicle navigates to the trailer, couples to the trailer, and drives the trailer to the specified location, such as an assigned door or dock in the distribution center.

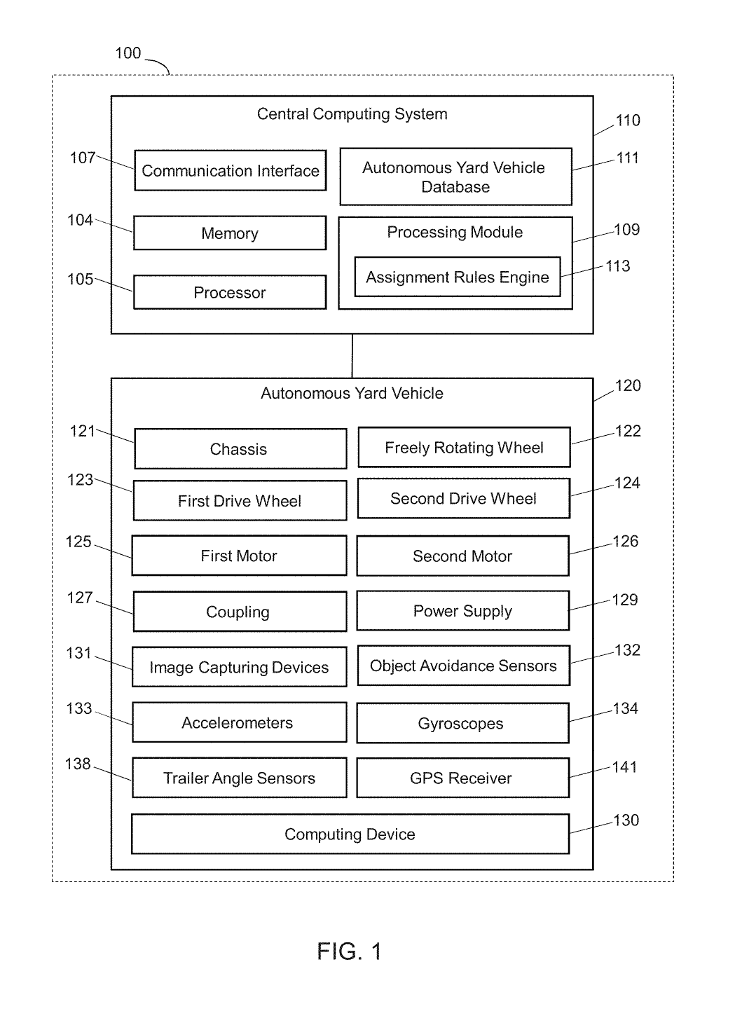

Referring now to FIG. 1, an exemplary autonomous yard vehicle system 100 includes a central computing system 110, and one or more autonomous yard vehicles 120. The central computing system 110 includes memory 104, a processor 105 and communication interface 107. The central computing system is configured to execute a processing module 109 and also includes or is able to access an autonomous yard vehicle database 111.

The autonomous yard vehicle database 111 includes information associated with the autonomous yard vehicles in the system 100, such as type of the autonomous yard vehicle, current location of each autonomous yard vehicle, trailer assignments of each autonomous yard vehicle, work schedule of each autonomous yard vehicle.

Processing module 109 includes an assignment rules engine 113 that assigns the autonomous vehicles in the distribution center to the cargo trailers to be moved based on particular rules from the assignment rules engine 113. For example, the assignment rules engine 113 can determine how to assign the autonomous yard vehicles 120 to the trailers based upon rules that are selected according to locations of the autonomous vehicles and the trailer, priority of movement of the trailer, freight requirements for the assigned door, and current trailer assignments for the autonomous yard vehicles 120.

Communication interface 107, in accordance with various embodiments can include, but is not limited to, a radio frequency (RF) receiver, RF transceiver, NFC device, a built-in network adapter, network interface card, PCMCIA network card, card bus network adapter, wireless network adapter, USB network adapter, modem or any other device suitable for interfacing with any type of network capable of communication and performing the operations described herein. Processor 105, in accordance with various embodiments can include, for example, but not limited to, a microchip, a processor (e.g., a central processing unit, a graphical processing unit), a microprocessor, a special purpose processor, an application specific integrated circuit, a microcontroller, a field programmable gate array, any other suitable processor, or combinations thereof. Central computing system 110 can also include memory such as but not limited to, hardware memory, non-transitory tangible media, magnetic storage disks, optical disks, flash drives, computational device memory, random access memory, such as but not limited to DRAM, SRAM, EDO RAM, any other type of memory, or combinations thereof.

As shown in FIG. 1, the autonomous yard vehicle 120 includes a chassis 121, one or more freely rotating wheels 122, two drive wheels 123, 124, two motors 125, 126 that drive the drive wheels 123, 124 respectively, a coupling component 127 that can be coupled to the trailer, power supply 129, and a computing device 130. The autonomous yard vehicle 120 also includes image capturing devices 131, object avoidance sensors 132, accelerometers 133, gyroscopes 134, trailer angle sensors 138, and GPS receiver 141, etc.

The image capturing devices 131, such as cameras, can be associated with the autonomous yard vehicle 120 to capture images of the environment surrounding the vehicle. For example, the image capturing devices 131 can capture an image of a trailer number and extract text from the captured image, such that the autonomous vehicle can identify the trailer to be moved. Alternatively, the autonomous vehicle can includes a barcode scanner or RFID reader to identify the trailer number by reading a barcode or an RFID associated with the trailers.

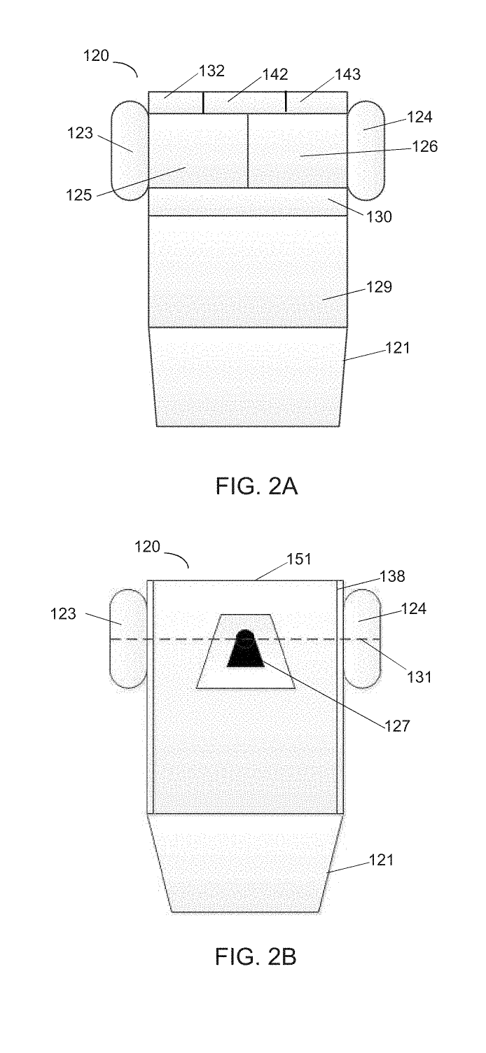

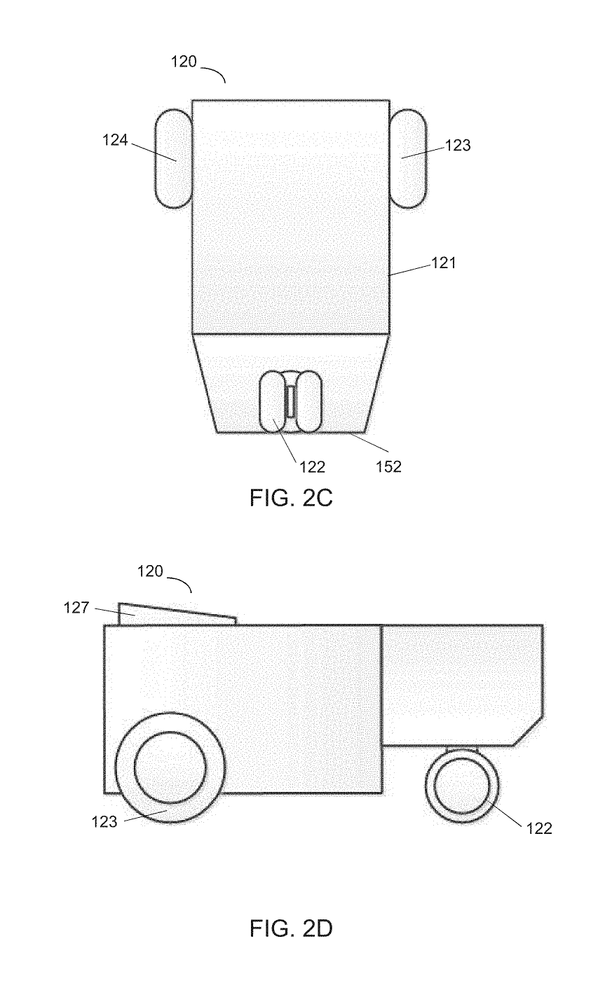

The object avoidance sensors 132 can detect other objects when the autonomous yard vehicle 120 is moving in the yard. The accelerometers 133 can be used in the autonomous yard vehicle 120 to measure acceleration forces. The gyroscopes 134 can be used to provide stability or maintain a reference direction for navigating the autonomous yard vehicle 120. The trailer angle sensors 138 can detect the angle between the autonomous yard vehicle 120 and the trailer. The GPS receiver 141 determines a geographic location of the autonomous yard vehicle 120. The structure of autonomous yard vehicle is described herein in more detail below with reference to FIGS. 2A-2D.

In one embodiment, the computing device 130 can be coupled to the autonomous yard vehicle system 120 and equipped with a processor and communication interface. The computing device 130 can receive instructions for assigning the autonomous yard vehicle 120 from the central computing system 110, and drive the wheels 123, 124 to navigate to the location instructed by the central computing system 110 based on the geographic location determined by the GPS receiver 141 and the detection results of the object avoidance sensors 132 and trailer angle sensors 138.

FIG. 2A illustrates a cutaway top view of an autonomous yard vehicle 120 in accordance with embodiments of the present disclosure. The autonomous yard vehicle 120 includes the chassis 121, as well as the first motor 125 and the second motor 126, which are supported by the chassis 121. A first drive wheel 123 can be driven by the first motor 125, and a second drive wheel 124 can be driven by the second motor 126 such that the first and second drive wheels 123, 124 are driven independent of each other. The first and second drive motors 125, 126 can drive the first and second drive wheels 123, 124, respectively, at various speeds and torques. The first and second drive wheels 123, 124 can be driven at the same speed and torque or at different speeds and torques. In one embodiment, the first drive wheel 123 can be drive at a first speed that is different from a second speed at which the second drive wheel 124 is driven. For example, when the autonomous vehicle is turning, the outside wheel can be driven at a speed faster than the inside wheel to facilitate turning of autonomous yard vehicle and cause less wear on the tires.

The autonomous yard vehicle 120 also includes the power supply 129 that supplies energy to the components of the autonomous yard vehicle 120. For example, the power supply 129 can include batteries, hydrogen cell, a diesel generator, energy harvesting devices (e.g., solar cells), etc.

The object avoidance sensors 132 can be disposed about the chassis to detect a position of the chassis 121 relative to objects in the environment surrounding the autonomous yard vehicle 120. For example, the object avoidance sensors 132 can detect the cargo trailers around the autonomous yard vehicle 120. In one embodiment, the object avoidance sensors 132 can be disposed on at least one side of the chassis 121. For example, as shown in FIG. 2A, the object avoidance sensors 132 are disposed adjacent to the first and second drive motors 125, 126 or the first and second drive wheels 123, 124. In other embodiments, other accessories of the vehicle, such as vehicle lights 142 and antennas 143, etc., can be disposed adjacent to the object avoidance sensors 132.

The system 120 further includes a computing system 130 operative coupled to the first and second drive motors 125, 126 and the object avoidance sensors 132. For example, the computing system 130 can include an onboard computer. The computing system 130 can be programmed to drive the first and second drive wheels 123, 124, via the first and second motors 125, 126, in response to outputs of the object avoidance sensors 132 to navigate to the cargo trailer and guide the coupling between the autonomous yard vehicle system and the cargo trailer.

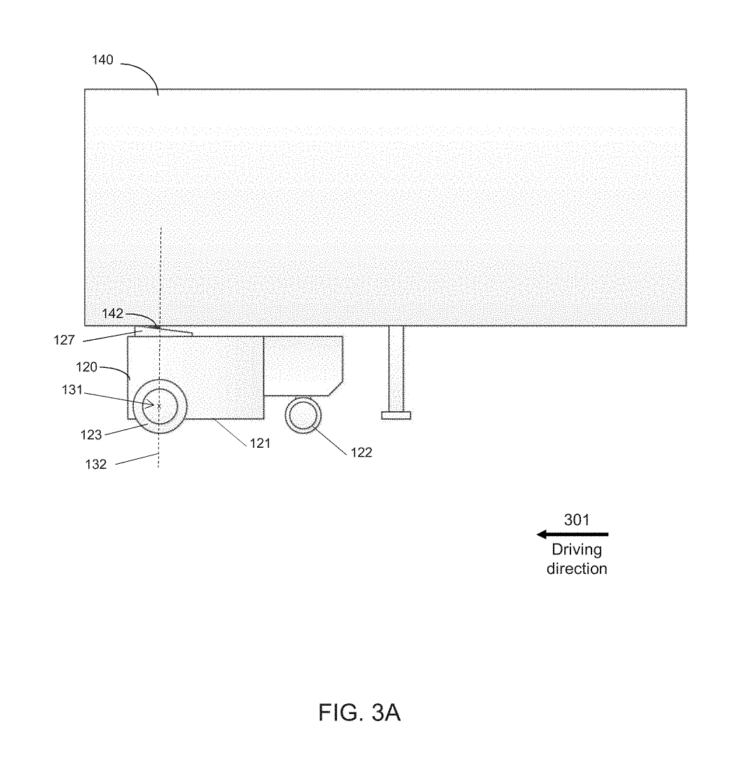

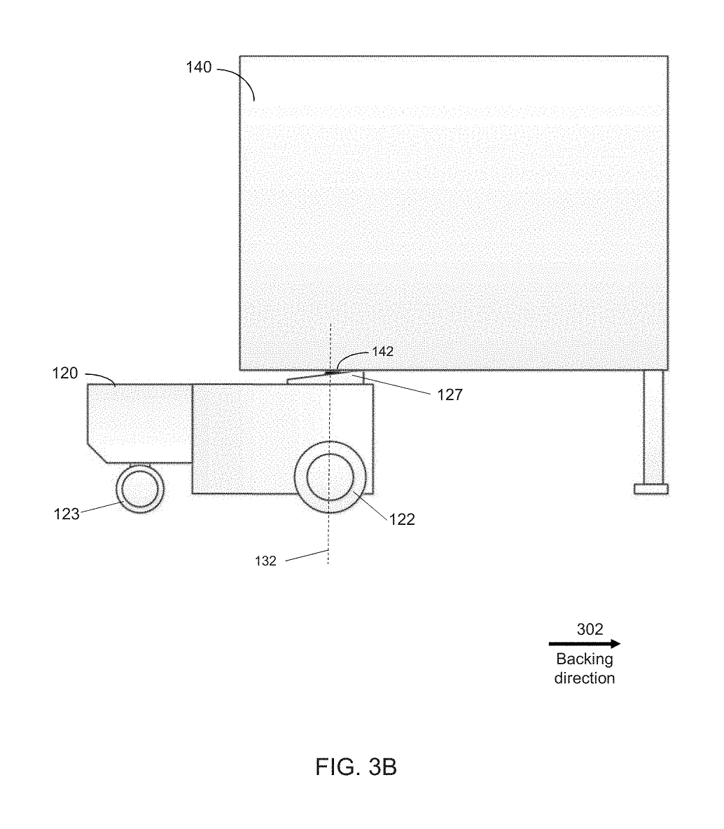

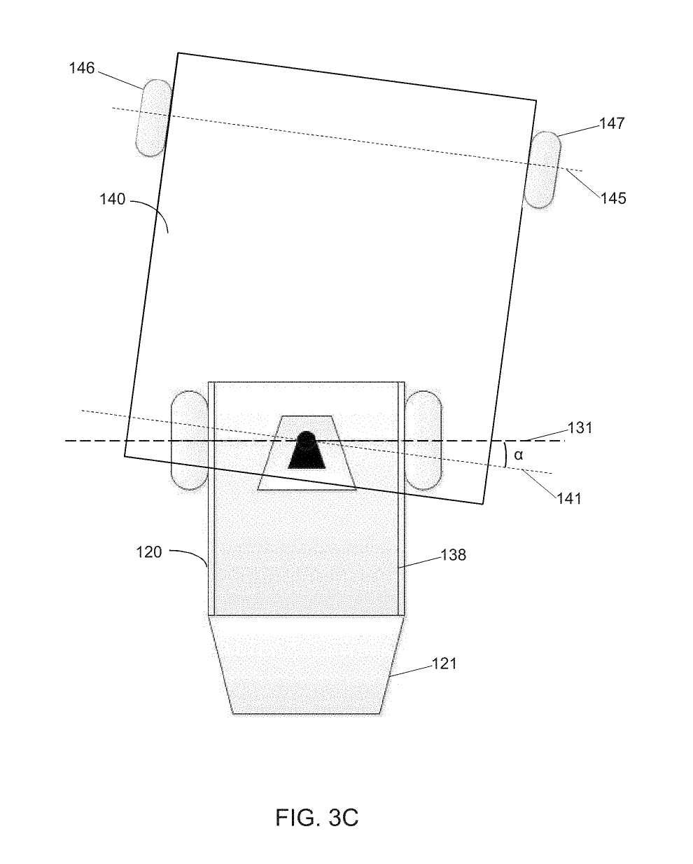

FIG. 2B illustrates a top view of the autonomous yard vehicle 120 in accordance with embodiments of the present disclosure. The first drive wheel 123 and the second drive wheel 124 are opposingly spaced from each other proximate to a proximal end 151 of the chassis 121 and aligned about a first axis of rotation 131. The system 120 further includes a coupling 127 operatively coupled to the chassis 121. The coupling 127 has a female connector, such as a slot, configured to receive and mechanically couple with a male connector of a cargo trailer, such as a kingpin. The trailer angle sensors 138 can be disposed in an array along one or both sides of the chassis 121. The trailer angle sensors 138 can be used to identify the angle between the autonomous yard vehicle 120 and a cargo trailer to be coupled or already coupled with the autonomous yard vehicle 120. The coupling between the autonomous yard vehicle system 120 and the cargo trailer is described herein in more detail below with respect to FIGS. 3A-3C. As shown in FIG. 2B, the slot of the coupling 127 is aligned with and vertically offset from the first axis of rotation 131.

FIGS. 2C and 2D illustrate a bottom view and a side view, respectively, of the autonomous yard vehicle 120 according to various embodiments of the present disclosure. The system 120 includes at least one freely rotating wheel 122 disposed proximate to a distal end 152 of the chassis 121. For example, the freely rotating wheel 122 can be a caster disposed on the chassis 121 and supporting the autonomous vehicle. The caster includes a housing coupled to the autonomous yard vehicle 120, and a wheel rotatable coupled to the housing.

FIGS. 3A and 3B illustrate side view of the autonomous yard vehicle 120 that is coupled with a cargo trailer 140 according to various embodiments of the present disclosure. As shown in FIG. 3A, the autonomous yard vehicle 120 is coupled with a cargo trailer 140 and driving forward in the direction shown as the arrow 301, and in FIG. 3B the autonomous yard vehicle 120 is coupled with the cargo trailer 140 and backing up in the direction shown as the arrow 302. Thus, the freely rotating wheel 122 trails the first and second drive wheels 123, 124 when the cargo trailer 140 is being pulled or pushed. Therefore, the freely rotating wheel 122, i.e., the caster, can stabilize the autonomous vehicle and the coupled trailer when the vehicle is driving.

In one embodiment, when a cargo trailer in the distribution center needs to be moved to a particular location, such as a door or a dock, an instruction to move the trailer can be sent to the computing device 130 coupled to the autonomous yard vehicle 120. In response to receiving the instruction, the computing device 130 can generate a route of navigating the autonomous yard vehicle 120 to the location of the cargo trailer 140 according to a map of the distribution center indicating the locations of the autonomous yard vehicle 120 and the cargo trailer 140. The route is also generated according to detection results from the sensors which indicate objects around the autonomous yard vehicle 120. In some embodiments the computing device can implement a simultaneous localization and mapping (SLAM) algorithm to generate a map of the environment and to maintain a location of the autonomous yard vehicle in the environment.

When the autonomous yard vehicle 120 is located in a proximity to the cargo trailer, the autonomous yard vehicle 120 identifies whether the cargo trailer is the correct trailer that needs to be coupled according to the instruction. The autonomous vehicle can identify the trailer by reading a barcode associated with the trailer using a barcode reader, extracting text from an image including a trailer number using an image capture device, and reading an RFID affixed to the trailer using a RFID reader, etc. If the trailer is the correct trailer, the computing device 130 can guide the slot of the coupling 127 to receive the kingpin 142 of the cargo trailer 140. The object avoidance sensors 132 can detect the position of the chassis 121 relative to the cargo trailer 140. Based on the detected position, the autonomous yard vehicle 120 can compute a distance between the coupling 127 and the kingpin 142 using the detected position of the cargo trailer, and can generate a route of moving the autonomous yard vehicle 120 to facilitate mechanical coupling between the slot of the coupling 127 and the kingpin 142.

After mechanically coupling the kingpin to the slot, the cargo trailer 140 can be autonomously navigated by the autonomous yard vehicle system 120 to a dock or a door for unloading freight from the cargo trailer or loading freight onto the cargo trailer. The first and second drive wheels 123, 124 of the autonomous yard vehicle can be independently driven by the first and second motors 125, 126 to rotate or pivot the chassis 121 about a second axis of rotation 132 as shown in FIGS. 3A and 3B. The second axis of rotation 132 perpendicularly intersects the first axis of rotation 131, and the kingpin 142 extends along the second axis of rotation 132, where the first axis of rotation 131 and the second axis of rotation 142 reside in a common vertical plane (i.e. at an angle normal to the earth). Therefore, when the trailer is coupled with the autonomous yard vehicle, the kingpin of the trailer is aligned with and vertically offset from the first axis of rotation 131. Aligning the first and second axes of rotation 131, 132, respectively, as described herein advantageously enables the trailer coupled to the autonomous yard vehicle to have a smaller turning radius than when the axes are out of alignment, which can be beneficial in navigating tight and/or crowded environment

FIG. 3C illustrates a schematic diagram of top view of the autonomous yard vehicle 120 coupled with the cargo trailer 140 according to various embodiments of the present disclosure. When the autonomous yard vehicle 120 coupled with the trailer 140 is driving, for example, moving straight or turning around other objects, the autonomous yard vehicle 120 can generate a route of travel based on the angle between the chassis 121 of the system 120 and the trailer 140, i.e., angle α in FIG. 3C.

Angle α, as shown in FIG. 3C, is formed by the first axis of rotation 131 of the vehicle 120 and direction 141 that is parallel with an axis of rotation 145 which the wheels 146, 147 of the trailer 140 are aligned about. Therefore, angle α represents the angle between the autonomous vehicle 120 and the trailer 140. The angle α between the autonomous yard vehicle 120 and the trailer 140 can be determined by the system 120 based on the position of the chassis 121 relative to the trailer 140 detected by the trailer angle sensors 138. The trailer angle sensors 138 can be disposed along one or both sides of the chassis 121 and include infrared (IR) reflective-type sensors. The infrared (IR) sensors emit infrared beams vertically in a direction parallel to the second axis of rotation 132, such that based on the infrared beams reflected by the bottom of the cargo trailer 140 and detected by the IR sensors, the angle of the chassis 121 relative to the cargo trailer 140 can be determined. Based on this angle between the chassis and the trailer, the system 120 can generate a route of travel when the kingpin 142 is mechanically coupled to the slot of the coupling 127 and/or can determine whether a current turning radius of the autonomous yard vehicle is unsafe at a given speed.

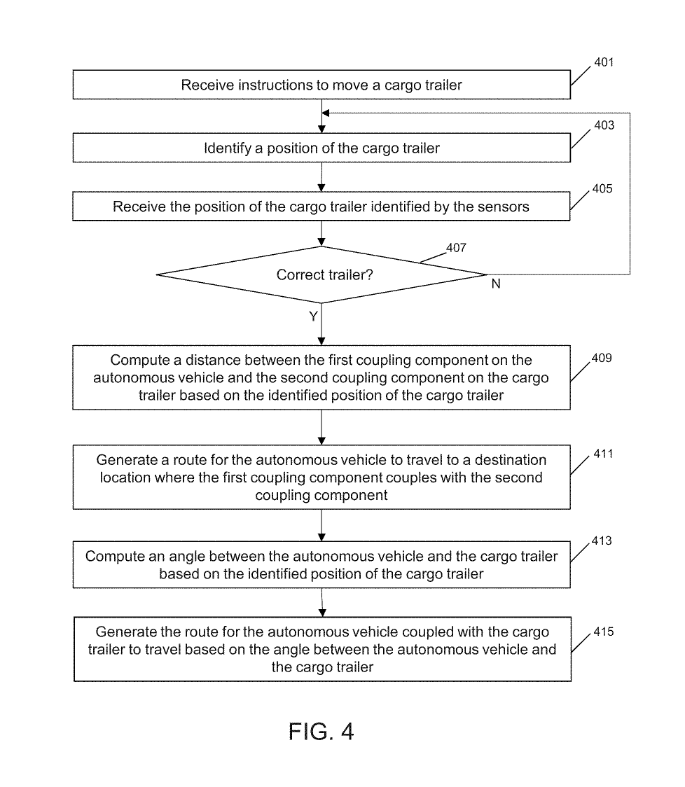

FIG. 4 is a flow diagram illustrating a method performed by the autonomous yard vehicle system for managing autonomous yard vehicles in a distribution center according to various embodiments of the present disclosure. In the distribution center, the autonomous vehicle includes a first coupling component, such as a slot, to couple with a second coupling component, such as a kingpin, on the cargo trailer, such that the autonomous yard vehicle can couple with the cargo trailer. At step 401, the autonomous vehicle receives instructions from the central computing system of the distribution center to move a cargo trailer. The autonomous vehicle further includes one or more cameras disposed on top of the vehicle to capture a 360-degree field of view. At step 403, the cameras located on top of the vehicle and the sensors located on at least one side of the autonomous vehicle can identify the position of a cargo trailer in the distribution center. At step 405 the computing system of the autonomous yard vehicle receives the position of the cargo trailer identified by the sensors. Each trailer has a trailer identification, such as a barcode, a trailer number, or a RFID tag. At step 407, the autonomous vehicle obtains the trailer identification, for example, by reading the barcode using a barcode reader, extracting the trailer number from an captured image including the trailer number using an image capture device, or reading the RFID tag using a RFID reader, and determines whether the identified trailer is the correct trailer that needs to be moved according to the instruction from the distribution center based on the obtained trailer identification. If not, the process goes back to step 403 and identifies positions of other cargo trailers.

If the identified trailer is determined as the correct trailer at step 407, when the autonomous yard vehicle is located in a predetermined proximity to the position of the cargo trailer, at step 409 the autonomous yard vehicle computes a distance between the slot on the autonomous vehicle and the kingpin on the cargo trailer based on the identified position of the cargo trailer. At step 411, the system generates a route for the autonomous vehicle to travel to a destination location where the slot can couple with the kingpin. After the cargo trailer is coupled with the autonomous yard vehicle, at step 413, an angle between the autonomous vehicle and the cargo trailer can be determined based on the identified position of the cargo trailer. The angle between the autonomous vehicle and the cargo trailer is used to ensure the approach of the vehicle to the kingpin is aligned to facilitate coupling, e.g., when the autonomous vehicle is navigated to couple the slot with the kingpin of the trailer, the vehicle backs straight in relative to the trailer.

At step 415, the system can generate a route for the autonomous vehicle coupled with the cargo trailer to travel based on the angle between the autonomous vehicle and the cargo trailer. Accordingly, when coupled with the cargo trailer, the autonomous vehicle can moving straight or turning around other objects without hitting obstacles in the yard of the distribution center.

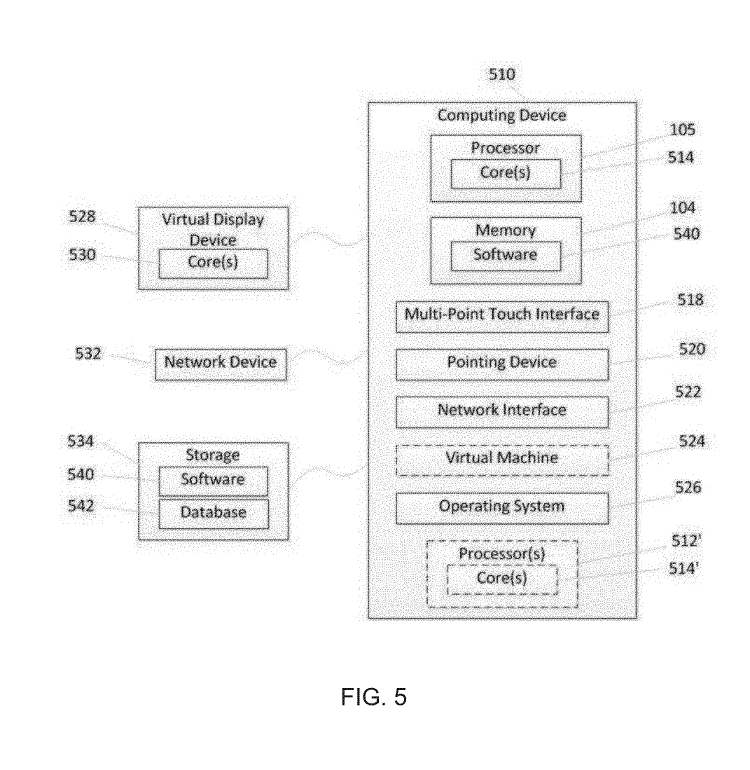

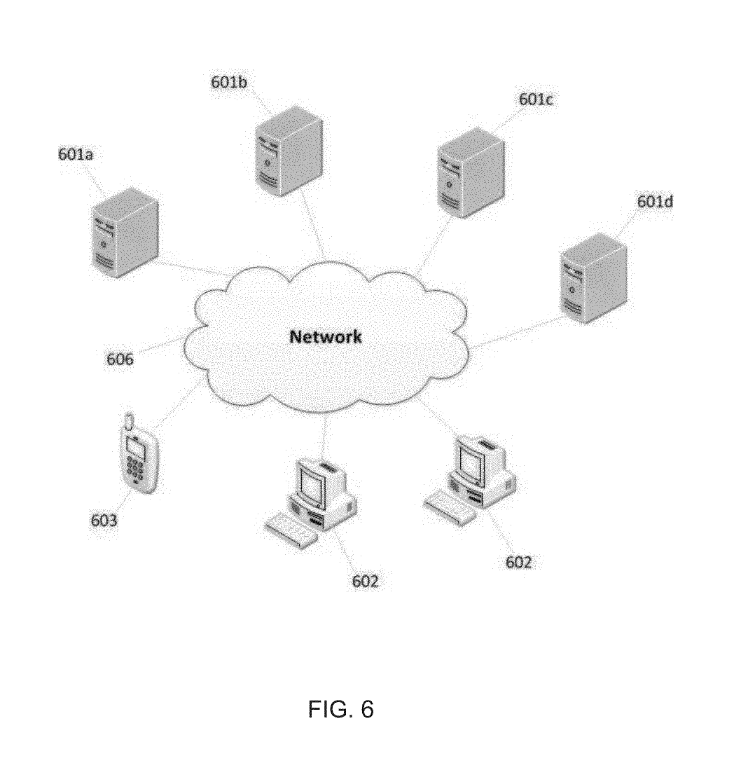

FIG. 5 is a block diagram of an exemplary computing device 510 such as can be used, or portions thereof, in accordance with various embodiments and, for clarity, refers back to and provides greater detail regarding various elements of the system 100 of FIG. 1. The computing device 510, which can be, but is not limited to the central computing system, the server, user mobile device, POS device and data capture devices described herein, can include one or more non-transitory computer-readable media for storing one or more computer-executable instructions or software for implementing exemplary embodiments. The non-transitory computer-readable media can include, but is not limited to, one or more types of hardware memory, non-transitory tangible media (for example, one or more magnetic storage disks, one or more optical disks, one or more flash drives), and the like. For example, memory 104 included in the computing device 510 can store computer-readable and computer-executable instructions or software for performing the operations disclosed herein. For example, the memory 104 can store a software application 540 which is configured to perform the disclosed operations (e.g., manage autonomous yard vehicles in a distribution center). The computing device 510 can also include configurable and/or programmable processor 105 and an associated core 514, and optionally, one or more additional configurable and/or programmable processing devices, e.g., processor(s) 512′ and associated core(s) 514′ (for example, in the case of computational devices having multiple processors/cores), for executing computer-readable and computer-executable instructions or software stored in the memory 104 and other programs for controlling system hardware. Processor 105 and processor(s) 512′ can each be a single core processor or multiple core (514 and 514′) processor.

Virtualization can be employed in the computing device 510 so that infrastructure and resources in the computing device can be shared dynamically. A virtual machine 524 can be provided to handle a process running on multiple processors so that the process appears to be using only one computing resource rather than multiple computing resources. Multiple virtual machines can also be used with one processor.

Memory 104 can include a computational device memory or random access memory, such as DRAM, SRAM, EDO RAM, and the like. Memory 104 can include other types of memory as well, or combinations thereof.

A user can interact with the computing device 510 through a visual display device 528, such as any suitable device capable of rendering texts, graphics, and/or images including an LCD display, a plasma display, projected image (e.g. from a Pico projector), Google Glass, Oculus Rift, HoloLens, and the like, and which can display one or more user interfaces 530 that can be provided in accordance with exemplary embodiments. The computing device 510 can include other I/O devices for receiving input from a user, for example, a keyboard or any suitable multi-point touch (or gesture) interface 518, a pointing device 520 (e.g., a mouse). The keyboard 518 and the pointing device 520 can be coupled to the visual display device 528. The computing device 510 can include other suitable conventional I/O peripherals.

The computing device 510 can also include one or more storage devices 534, such as a hard-drive, CD-ROM, flash drive, or other computer readable media, for storing data and computer-readable instructions and/or software that perform operations disclosed herein. In some embodiments, the one or more storage devices 534 can be detachably coupled to the computing device 510. Exemplary storage device 534 can also store one or more software applications 540 for implementing processes of the autonomous yard vehicle system described herein and can include databases 542 for storing any suitable information required to implement exemplary embodiments. The databases can be updated manually or automatically at any suitable time to add, delete, and/or update one or more items in the databases. In some embodiments, at least one of the storage device 534 can be remote from the computing device (e.g., accessible through a communication network) and can be, for example, part of a cloud-based storage solution.

The computing device 510 can include a network interface 522 configured to interface via one or more network devices 532 with one or more networks, for example, Local Area Network (LAN), Wide Area Network (WAN) or the Internet through a variety of connections including, but not limited to, standard telephone lines, LAN or WAN links (for example, 802.11, Ti, T3, 56 kb, X.25), broadband connections (for example, ISDN, Frame Relay, ATM), wireless connections, controller area network (CAN), or some combination of any or all of the above. The network interface 522 can include a built-in network adapter, network interface card, PCMCIA network card, card bus network adapter, wireless network adapter, USB network adapter, modem or any other device suitable for interfacing the computing device 510 to any type of network capable of communication and performing the operations described herein. Moreover, the computing device 510 can be any computational device, such as a workstation, desktop computer, server, laptop, handheld computer, tablet computer, or other form of computing or telecommunications device that is capable of communication and that has sufficient processor power and memory capacity to perform the operations described herein.

The computing device 510 can run operating systems 526, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or other operating systems capable of running on the computing device and performing the operations described herein. In exemplary embodiments, the operating system 526 can be run in native mode or emulated mode. In an exemplary embodiment, the operating system 526 can be run on one or more cloud machine instances.

FIG. 6 is a block diagram of exemplary distributed and/or cloud-based embodiments. Although FIG. 1, and portions of the exemplary discussion above, make reference to an autonomous yard vehicle system 100 operating on a single computing device, one will recognize that various of the modules within the autonomous yard vehicle system 100 may instead be distributed across a network 606 in separate server systems 601a-d and/or in other computing devices, such as a desktop computer device 602, or mobile computer device 603. As another example, the user interface provided by the mobile application 123 can be a client side application of a client-server environment (e.g., a web browser or downloadable application, such as a mobile app), wherein the processing module 109 is hosted by one or more of the server systems 601a-d (e.g., in a cloud-based environment) and interacted with by the desktop computer device or mobile computer device. In some distributed systems, the modules of the system 100 can be separately located on server systems 601a-d and can be in communication with one another across the network 606.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with a multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. An autonomous yard vehicle system, the system comprising:
a chassis;
at least one freely rotating wheel disposed proximate to a distal end of the chassis;
a first drive wheel driven by a first motor supported by the chassis;
a second drive wheel driven by a second motor supported by the chassis, the first and second drive wheels being opposingly spaced from each other proximate to a proximal end of the chassis and aligned about a first axis of rotation;
a coupling operatively coupled to the chassis, the coupling having a slot configured to receive and mechanically couple with a kingpin of a cargo trailer, the slot being aligned with and vertically offset from the first axis of rotation;
a plurality of sensors disposed about the chassis; and
a computing system operative coupled to the first and second motors and the plurality of sensors, the computing system being programmed to drive the first and second drive wheels via the first and second motors in response to one or more outputs of one or more of the plurality of sensors to navigate to the cargo trailer and guide the slot of the coupling to receive the kingpin,
wherein, in response to mechanically coupling the kingpin to the slot, the first and second drive wheel are configured to be independently driven to rotate the chassis about a second axis of rotation that intersects the first axis of rotation, the kingpin extending along the second axis of rotation.

2. The system of claim 1, wherein the plurality of sensors are disposed on at least one side of the chassis and are configured to detect a position of the chassis relative to the cargo trailer.

3. The system of claim 2, wherein the computing system is configured to:
compute a distance between the coupling and the kingpin based on the detected position of the cargo trailer when the chassis is within a specified distance of the cargo trailer;
generate a route of travel to facilitate mechanical coupling of the slot and the kingpin;
compute an angle between the chassis and the cargo trailer based on the detected position of the chassis relative to the cargo trailer when the kingpin is mechanically coupled to the slot.

4. The system of claim 3, wherein the computing system is configured to generate the route to travel based on the angle between the chassis and the cargo trailer.

5. The system of claim 3, wherein at least a subset of the plurality of sensors includes infrared (IR) sensors, and the IR sensors configured to emit infrared beams vertically in a direction parallel to the second axis of rotation.

6. The system of claim 5, wherein the angle of the chassis relative to the cargo trailer is identified based on reflected infrared beams, the reflected infrared beams being reflected by a bottom of the cargo trailer and detected by the plurality of IR sensors.

7. The system of claim 1, wherein the first drive wheel is driven by the first motor at a first speed and the second drive wheel is driven by the second motor at the second speed to rotate the chassis about the second axis of rotation.

8. The system of claim 1, wherein the freely rotating wheel is caster.

9. The system of claim 1, wherein the freely rotating wheel trails the first and second drive wheels when the cargo trailer is being pulled.

10. The system of claim 9, wherein, in response to mechanical coupling of the kingpin to the slot, the cargo trailer is autonomously navigated to a dock door for unloading freight from the cargo trailer.

11. A computer-implemented method for managing autonomous yard vehicles in a geographical area, comprising:
locating a plurality of sensors on at least one side of an autonomous vehicle, the autonomous vehicle being configured to couple and move one of a plurality of cargo trailers and comprising a first coupling component configured to couple with a second coupling component on the cargo trailer;
identifying a position of the cargo trailer;
receiving, by a computing system, in communication with the autonomous vehicle, the position of the cargo trailer identified by the plurality of sensors;
computing, by the computing system, a distance between the first coupling component on the autonomous vehicle and the second coupling component on the cargo trailer based on the identified position of the cargo trailer when the autonomous vehicle is located in a predetermined proximity to the identified position of the cargo trailer;
generating, by the computing system, a route for the autonomous vehicle to travel to a destination location where the first coupling component couples with the second coupling component; and
computing, by the computing system, an angle between the autonomous vehicle and the cargo trailer based on the identified position of the cargo trailer when the cargo trailer is coupled with the autonomous vehicle.

12. The method of claim 11, further comprising:
generating, by the computing system, the route for the autonomous vehicle coupled with the cargo trailer to travel based on the angle between the autonomous vehicle and the cargo trailer.

13. The method of claim 11, wherein the plurality of sensors include infrared (IR) sensors, and the IR sensors emit infrared beam vertically from a top of the autonomous vehicle.

14. The method of claim 13, wherein the position of the cargo trailer is identified based on reflected infrared beam, the reflected infrared beam being reflected by a bottom of the cargo trailer and detected by the plurality of IR sensors.

15. The method of claim 11, wherein the sensors are distributed along the at least one side of the autonomous vehicle.

16. The method of claim 11, wherein the first coupling component is a slot, and the second coupling component is a kingpin.

17. The method of claim 11, wherein the plurality of sensors are configured to detect objects around the autonomous vehicle, and the method further comprises generating, by the computing system, the route for the autonomous vehicle to travel based on detection result of the plurality of detecting components and a map of the geographical area.

18. The method of claim 11, wherein the autonomous vehicle further comprises a first drive wheel driven by a first motor, and a second drive wheel driven by a second motor.

19. The method of claim 18, further comprising:
driving the first drive wheel by the first motor at a first speed; and
driving the second drive wheel by the second motor at the second speed.

20. The method of claim 11, wherein the autonomous vehicle further comprises at least one caster supporting the autonomous vehicle, the caster including a housing configured to be coupled to the autonomous vehicle and a wheel rotatable coupled to the housing.
